(19) United States
(12) Patent Application Publication
(10) Pub. No.: US 2010/0257958 A1
(43) Pub. Date: Oct. 14, 2010

(54) DOUBLE CLUTCH TRANSMISSION

(75) Inventors: Wolfgang RIEGER, Friedrichshafen (DE); Matthias REISCH, Ravensburg (DE); Juergen WAFZIG, Eriskirch (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,963

(22) Filed: Apr. 13, 2010

(30) Foreign Application Priority Data
Apr. 14, 2009 (DE) 10 2009 002 348.8

(51) Int. Cl. F16H 3/093

(52) U.S. Cl. 74/330

(57) ABSTRACT

A double clutch transmission with two clutches with input sides connected to a drive shaft and output sides each respectively connected to one of two transmission input shafts disposed coaxially to one another. At least two countershafts are provided upon which toothed idler gearwheels are mounted in a rotatable manner and toothed fixed gearwheels are disposed on the two transmission input shafts in a rotationally fixed manner. At least one shift element is provided for connecting two idler gearwheels in a rotationally fixed manner such that at least several power shiftable forwards gears and/or at least one reverse gear can be shifted. A maximum of six gear planes are provided so that at least one power shiftable winding path gear can be shifted using the at least one shift element.

This application claims priority from German patent application serial no. 10 2009 002 348.8 filed Apr. 14, 2009.

### FIELD OF THE INVENTION

The present invention relates to a double clutch transmission.

### BACKGROUND OF THE INVENTION

A six-speed or seven-speed double clutch transmission is known from the published patent DE 103 05 241 A1. The double clutch transmission comprises two clutches each having their input side connected to the driveshaft, and their output side connected to one of the two transmission input shafts. The two transmission input shafts are disposed coaxially to each other. In addition, two countershafts are disposed axially parallel to the two transmission input shafts, whose idler gears mesh with fixed gears of the transmission input shafts. Furthermore, coupling devices that are axially movable and held in a rotationally fixed manner on the countershafts, in order to be able to shift to the respective toothed gearwheel. The respectively selected transmission ratio is transferred via the output gears to a differential. In order to realize the desired transmission ratio steps for the known double clutch transmissions, a plurality of gear planes is necessary such that significant construction space is required during installation.

Further, a spur-gear multi-speed transmission is known from the published patent DE 38 22 330 A1. The spur-gear multi-speed transmission comprises a double clutch transmission that can be shifted under load, and whose one part is connected to driveshaft and the other part is connected to a hollow driveshaft, mounted in a rotatable manner on the driveshaft. The driveshaft can be coupled to the hollow driveshaft via a shift element for specific transmission ratios.

A power shift transmission with two clutches, which are each assigned a subtransmission, is known from the published patent DE 10 2004 001 961 A1. The transmission input shafts of the two subtransmissions are arranged coaxially to each other and via fixed gears mesh with idler gears of the associated countershafts. The respective idler gears of the countershafts can be connected to the respective countershaft in a rotationally fixed manner by means of associated shift elements. From this patent document, an eight-speed transmission is known in which a further shift element is provided for coupling the two transmission input shafts in order to realize a further transmission ratio step. Even the seven-speed transmission with this embodiment requires at least six gear planes in the two subtransmissions in order to realize the transmission ratio steps. This leads to undesired elongation of the construction length in the axial direction, so that the possibility of installation in a vehicle is significantly restricted.

In addition, from the published patent DE 10 2005 028 532 A1, a further power shift transmission is known which comprises two input shafts and only one countershaft. An eight-speed transmission in this embodiment requires at least seven gear planes in order be able to realize the transmission ratio steps. This leads to undesired elongation of the overall construction length in the axial direction.

### SUMMARY OF THE INVENTION

The object of the present invention is to propose a double clutch transmission of the initially described type, in which multiple power shiftable transmission ratio steps are realized as cost-effectively as possible, and with the fewest possible components, while requiring little construction space.

Accordingly, a double clutch transmission that is optimized with regard to construction space, having two clutches is proposed, whose input sides are connected to a driveshaft, and whose output sides are connected respectively to one of two transmission input shafts disposed coaxially to each other. The double clutch transmission comprises at least two countershafts or similar, on which toothed gearwheels designed as idler gears are mounted in a rotational manner, wherein toothed gearwheels are disposed on both transmission inputs shafts in a rotationally fixed manner, and are designed as fixed gears, at least some of which mesh with the idler gears. Further, multiple coupling devices are provided for connecting an idler gear to a countershaft in a rotationally fixed manner. The double clutch transmission according to the invention has, in each case, an output gear or constant pinion, provided on each of the countershafts, that is coupled to gearing of a driveshaft in order to connect the respective countershaft to the output drive, and at least one shift element or similar that can be activated or engaged as a so-called winding path gear-shift element for the rotationally fixed connection of two toothed gearwheels, wherein several power shiftable gears are feasible.

The proposed double clutch transmission according to the invention preferably comprises a maximum of six gear planes, with which at least seven power shiftable gear are realized with little construction space required. For example, the maximum six gear planes can comprise at least one dual gear plane, wherein in each dual gear plane respectively one idler gear of the first and second countershafts are assigned a fixed gear of one of the transmission input shafts, and at least one idler gear can be used for at least two gears such that at least two winding path gears can be shifted using at least one shift element.

It is also possible, that in addition to the dual gear planes also single gear planes are used, wherein with each single gear plane an idler gear of the countershaft is assigned to a fixed gear of one of the transmission input shafts. Other configurations are also possible.

Due to the possible multiple uses of idler gears with the proposed double clutch transmission, a maximum number of transmission ratios can be realized with the fewest possible gear planes, wherein preferably the first seven forward gears are power shiftable in sequential implementation.

To optimize the stepping with the proposed double clutch transmission according to the invention, a dual gear plane can also be replaced by two individual gear planes, in that one fixed gear is replaced by two fixed gears. Thereby, particularly harmonic, progressive gear stepping can be attained. It is also possible to replace two single gear planes by a dual gear plane.

The proposed double clutch transmission can preferably be implemented as an eight-speed transmission with at least seven power shiftable gear steps. Due to the short construction compared to known transmission arrangements, the double clutch transmission according to the invention is particularly suited for a front transverse construction in a vehicle. However, other installation implementations are also possible depending on the type and construction space of the respective vehicle in question.

Preferably, with the proposed double clutch transmission, the first and the eighth forward gears can each be a winding path gear. In addition, one reverse and/or further gears, for instance, crawler gears or overdrive gears, can also be implemented as a winding path gear, and can possibly also be designed to be power shiftable.

In an advantageous manner, with the proposed double clutch transmission an additional overdrive gear that is power shiftable to the seventh forward gear, results as an alternative power shiftable eighth forward gear, whereby fuel can be saved with the vehicle.

As an example, depending on the embodiment, the first countershaft can be assigned four shiftable idler gears, and the second countershaft can be assigned three or four shiftable idler gears, which in each case mesh with fixed gears of the assigned transmission input shaft.

If the last or next-to-last gear increment is designed higher than the respectively previous one, particularly high drive torque or drive power can be made available, in the event of a downshift requested by the driver.

In an advantageous manner with the double clutch transmission according to the invention, at most five shift positions are necessary on a countershaft. In total, only nine shift positions are used together on the two countershafts in order to realize the proposed gear steps.

According to the invention it can be provided that by means of at least one shift element on the first countershaft, the idler gear of the second subtransmission can be connected to the idler gear of the first subtransmission, so that via the shift element at least a first forward gear, an eighth forward gear, at least a crawler gear and/or at least an overdrive gear can be shifted respectively as a winding path gear.

Further, it can be provided that by means of an alternative or additional shift element on the second countershaft, an idler gear of the second subtransmission can be connected to an idler gear of the first subtransmission, wherein via the shift element a first forward gear, an eighth forward gear, a reverse gear, a crawler gear and/or an overdrive gear can be shifted respectively as a winding path gear.

Consequently, using at least one shift element or also using both shift elements, with the double clutch transmission according to the invention, winding path gears can be realized, in which toothed gearwheels of both subtransmissions are coupled together in order to thereby realize a flow of power through both subtransmissions. Here, the shift element used in each case serves to couple two idler gears, and thereby brings the transmission input shafts into dependency on each other.

In the double clutch transmission, the arrangement of the shift elements can be varied for coupling two specific idler gears so that the shift elements need not necessarily be disposed between the idler gears to be coupled. Accordingly, other arrangement positions of the respective shift elements are conceivable, in order to optimize linkage to an actuator system.

With the double clutch transmission according to one possible embodiment it can be provided that the first gear plane and the second gear plane respectively as dual gear planes comprise two fixed gears on the second transmission input shaft of the second subtransmission, the fourth gear plane and the fifth gear plane respectively as dual gear planes comprise two fixed gears on the first transmission input shaft of the first subtransmission.

In the scope of a further variant embodiment of the invention, it can also be provided with the proposed double clutch transmission that the first gear plane as a single gear plane, and the second gear plane as a dual gear plane, comprise two fixed gears on the second transmission input shaft of the second subtransmission, the third gear plane and the fourth gear plane respectively as single gear planes and the fifth gear plane as a dual gear plane comprise three fixed gears on the first transmission input shaft of the first subtransmission. It is also possible that the fifth gear plane is designed as a single gear plane, and an additional sixth gear plane is provided as a single gear plane, which is assigned to a further fixed gear of the first transmission input shaft.

Furthermore, a next variant embodiment of the double clutch transmission can provide that the first gear plane as a dual gear plane, and the second gear plane and the third gear plane respectively as single gear planes, comprise three fixed gears on the second transmission input shaft of the second subtransmission, the fourth gear plane and the fifth gear plane respectively as dual gear planes comprise two fixed gears on the first transmission input shaft of the first subtransmission. It is also possible that the fifth gear plane is designed as a single gear plane, and an additional sixth gear plane is provided as a single gear plane, which is assigned to a further fixed gear of the first transmission input shaft of the first subtransmission.

In order to provide the necessary reversal of rotation for implementing reverse gears with the double clutch transmission according to the invention at least one intermediate gear or similar can be used that is disposed on an intermediate shaft. It is also possible that one of the idler gears of a countershaft serves as an intermediate gear for at least one reverse gear. No additional intermediate shaft is then necessary for the reverse gear transmission ratio because one of the idler gears meshes both with a fixed gear as well as also with a further shiftable idler gear of the other countershaft. Consequently, the intermediate gear required for the reverse gear is disposed as a shiftable idler gear on a countershaft, and serves, in addition, to implement at least one further forward gear. The intermediate gear can also be implemented as a stepped gear independent of whether this is disposed on the countershaft or on an additional intermediate shaft. It is also possible that the intermediate gear is not disposed on one of the countershafts that are already present, rather it can be provided on a further separate shaft, a third countershaft.

In order to obtain the desired transmission ratio steps it can be provided with the double clutch transmission according to the invention that at least one bidirectionally operative coupling device or similar is disposed at each countershaft. The provided coupling devices can in the activated or engaged state, depending on the direction of actuation connect an associated idler gear to the countershaft in a rotationally fixed manner. In addition, a unidirectionally operative coupling device or similar can also be disposed on at least one of the countershafts. As coupling devices hydraulically, electrically, pneumatically, or mechanically actuated clutches or also form-locking claw clutches, can be used as well as any type of synchronization device, which serve for the rotationally fixed connection of an idler gear to a countershaft. It is also possible to replace a bidirectionally operative coupling device by two unidirectionally operative coupling devices or vice versa.

With the proposed double clutch transmission, it is conceivable that the specified arrangement possibilities of the toothed gear wheels vary, and also the number of toothed gearwheels as well as the number of coupling devices are changed in order to realize still further gears that can, or cannot, be power shifted, and to realize construction space savings and component savings. In particular, fixed gears of dual gear planes can be divided into two fixed gears for single gear planes. Thereby, step changes can be improved. In addition, it is also possible to interchange the countershafts. The subtransmissions can also be interchanged, i.e., mirrored about a vertical axis. In the process, hollow shafts and solid shafts are interchanged. As a result, it is possible, e.g. to dispose the smallest gear on the solid shaft in order to further optimize the use of the existing construction space. Furthermore, adjacent gear planes can be interchanged in order to optimize shaft deflection and/or to optimally link a shift actuating system. In addition, the respective arrangement of the coupling devices on the gear plane can be varied. Furthermore, the effective direction of the coupling devices can also be changed.

The gear numbering used here were freely defined. It is also possible to add a crawler or crawler gear and/or an overdrive or overdrive gear, in order to improve the off-road properties or the acceleration behavior of a vehicle. In addition, a first gear can be omitted to better optimize the entirety of the step changes. The gear numbering varies correspondingly with these measures.

Independent of the respective variant embodiments of the double clutch transmission, the driveshaft and the output shaft can preferably be arranged non-coaxially to each other, which realizes a particularly construction space saving arrangement. For example, the shafts thus disposed spatially after each other, can also be offset slightly to each other. With this arrangement, a direct gear with a transmission ratio of one can be realized using meshing, and in an advantageous way can be placed relatively freely onto the sixth to ninth gear. Other arrangement possibilities of the driveshaft and the output shaft are also conceivable.

Preferably the proposed double clutch transmission is equipped with integrated output stages. The output stage can comprise a fixed gear on the output shaft as an output gear, which meshes with a first output gear as a fixed gear of the first countershaft, and a second output gear as a fixed gear of the second countershaft. However it is also possible that at least one of the output gears is designed as a shiftable gear. In addition, for example, at least one output gear can be assigned a coupling device which in the disengaged state breaks the connection between the assigned countershaft and the output gear.

In an advantageous manner, the lower forward gears and the reverse gears can be actuated using a startup clutch or shifting clutch, to consequently concentrate higher loads onto this clutch, and thereby to be able to implement the second clutch in a more cost-effective and construction space saving manner. In particular, the gear planes with the proposed double clutch transmission can be disposed such that start-up is possible via the inner transmission input shaft or also the outer transmission input shaft, and thus via the respectively better suited clutch, which is also enabled with a concentrically arranged, radially nested construction of the double clutch. In addition, the gear planes can be disposed correspondingly mirror symmetrically or interchanged.

Independent of the respective variant embodiment of the double clutch transmission, the provided gear planes can be interchanged.

### BRIEF DESCRIPTION OF THE DRAWINGS

The present invention is described in the following in more detail with reference to the drawings. They show:

FIG. 1 a schematic view of a first variant embodiment of an eight-speed double clutch transmission according to the invention;

FIG. 2 a shift pattern of the first variant embodiment according to FIG. 1;

FIG. 3 a schematic view of a second variant embodiment of an eight-speed double clutch transmission according to the invention;

FIG. 4 a shift pattern of the second variant embodiment according to FIG. 3;

FIG. 5 a schematic view of a third variant embodiment of an eight-speed double clutch transmission according to the invention;

FIG. 6 a shift pattern of the third variant embodiment according to FIG. 5;

FIG. 7 a schematic view of a fourth variant embodiment of an eight-speed double clutch transmission according to the invention;

FIG. 8 a shift pattern of the fourth variant embodiment according to FIG. 7;

FIG. 9 a schematic view of a fifth variant embodiment of an eight-speed double clutch transmission according to the invention;

FIG. 10 a shift pattern of the fifth variant embodiment according to FIG. 9.

### DETAILED DESCRIPTION OF THE PREFERRED EMBODIMENTS

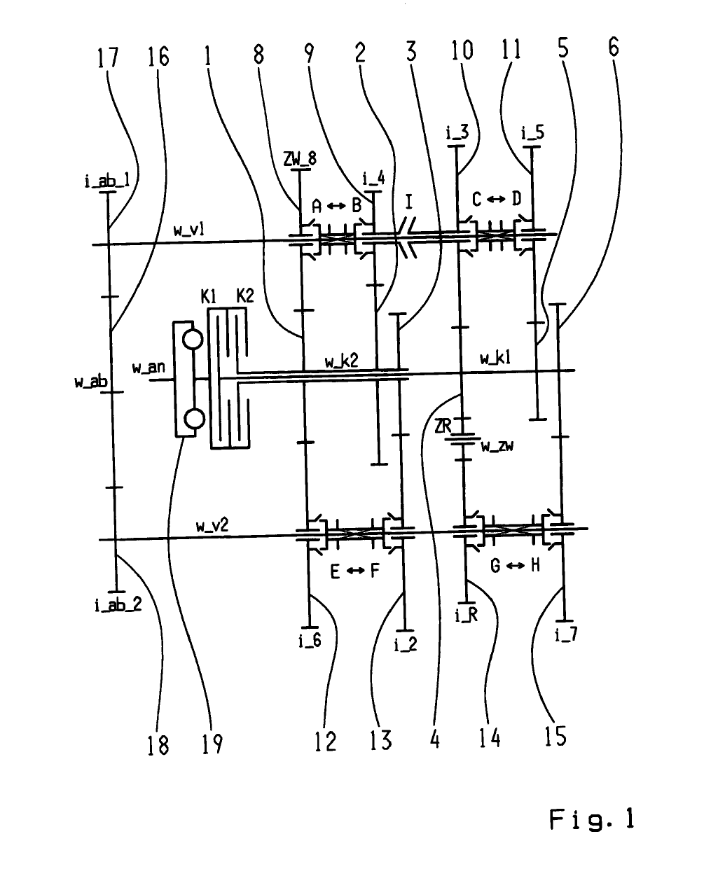

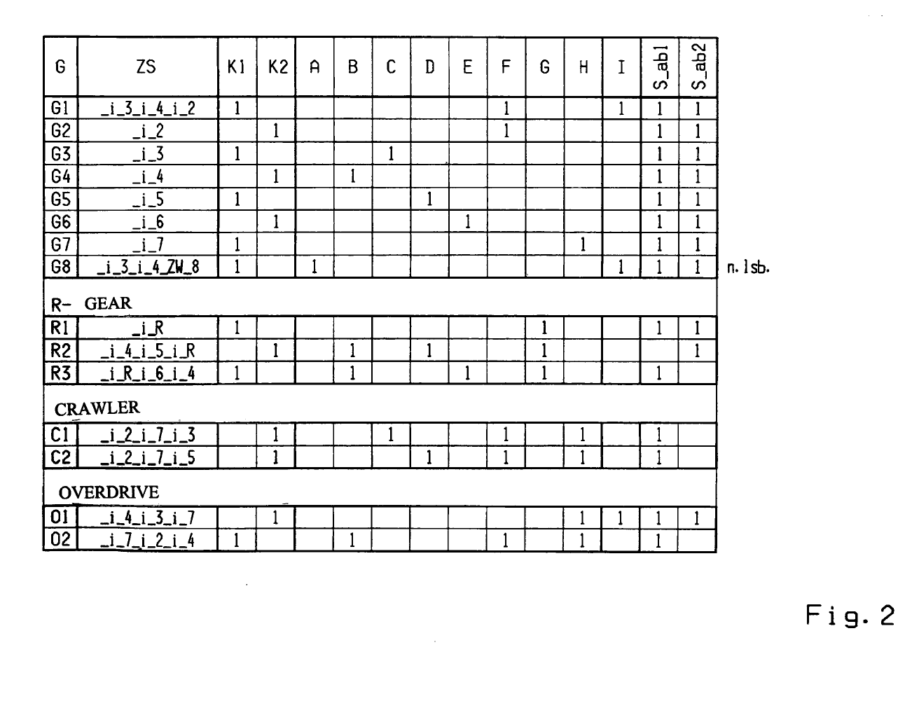

The FIGS. 1, 3, 5, 7 and 9 each show a possible variant embodiment of an eight-speed double clutch transmission. The respective shift patterns for the different variant embodiments are shown in tabular form in the FIGS. 2, 4, 6, 8 and 10.

The eight-speed double clutch transmission comprises two clutches K1, K2 whose input sides are connected to a driveshaft w_an, and whose output sides are respectively connected to one of two transmission input shafts w_k1, w_k2, disposed coaxially to each other. In addition, a torsional vibration damper 19 can be disposed on the driveshaft w_an. Furthermore, two countershafts w_v1, w_v2 are provided, on which toothed gearwheels designed as idler gears 8, 9, 10, 11, 12, 13, 14, 15 are mounted in a rotational manner. Toothed gear wheels designed as fixed gears 1, 2, 3, 4, 5, 6 are disposed on the two transmission input shafts w_k1, w_k2 in a rotationally fixed manner, and at least some of which mesh with the idler gears 8, 9, 10, 11, 12, 13, 14, 15.

In order to connect the idler gears 8, 9, 10, 11, 12, 13, 14, 15 to the respective countershaft w_v1, w_v2, multiple coupling devices A, B, C, D, E, F, G, H that can be activated are provided on the countershafts w_v1, w_v2. Furthermore, output gears 17, 18 are disposed on the two countershafts w_v1, w_v2 as constant pinions, which are, in each case, coupled to a gearing of a fixed gear 16 of an output shaft w_ab, wherein appropriate output stages i_ab_1, i_ab_2 are assigned to the output gears 17, 18.

Along with the coupling devices A, B, C, D, E, F, G, H which realize a rotationally fixed connection between a toothed gear wheel and the associated countershaft w_v1, w_v2, with the double clutch transmission at least one winding path gear-shift element I, K is provided for a rotationally fixed connection of two toothed gearwheels of a countershaft w_v1, w_v2, so that at least one winding path gear is realized.

With the double clutch transmission according to the invention, maximally six gear planes 8-1, 8-12, 9-2, 9-13, 3-13, 10-3, 4-14, 10-14, 11-5, 11-15, 6-15 are provided, wherein in each variant embodiment at least one dual gear plane 8-12, 9-13, 10-14, 11-15 is provided so that at least two winding path gears can be shifted using at least one activated shift element I, K. As a shift element I, K, in each case, a pawl or similar can be used for the connection of two gears or similar.

The shift element K, if present, is disposed on the second countershaft w_v2, in order to connect the idler gear 13 to the idler gear 14, when the shift element K is activated. The shift element I, if present, is disposed on the first countershaft w_v1, in order to connect the idler gear 9 to the idler gear 10, when the shift element I is activated.

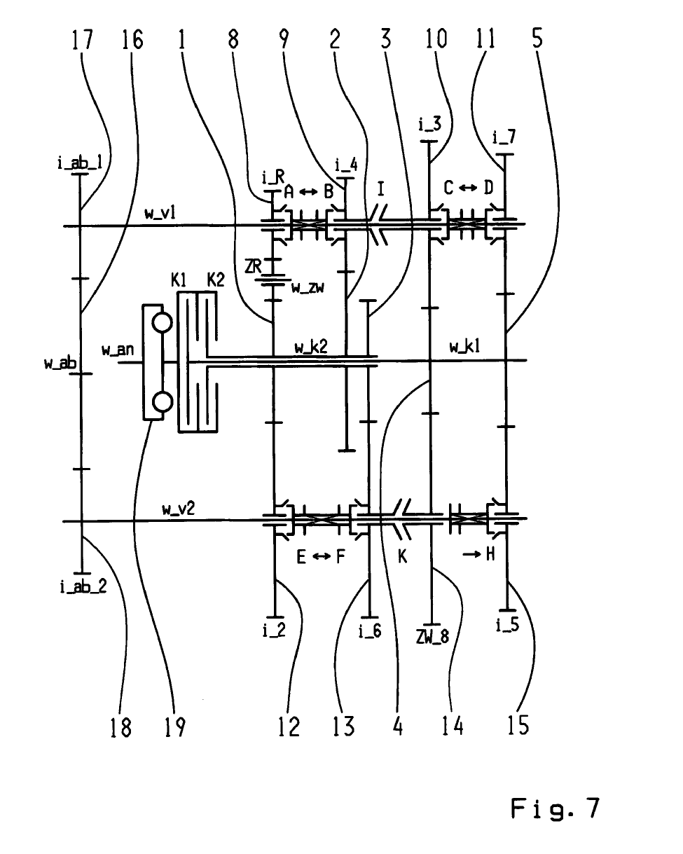

In the first variant embodiment according to FIG. 1, in the first gear plane 8-12 as a dual gear plane, the fixed gear 1 of the second transmission input shaft w_k2 meshes with both the idler gear 12 of the second countershaft w_v2 as well as with the idler gear 8 of the first countershaft w_v1. In contrast to this, in the fourth variant embodiment according to FIG. 7, the fixed gear 1 does not mesh directly with the idler gear 8, but rather indirectly via an intermediate gear ZR on an intermediate shaft w_zw, the intermediate gear ZR then meshes directly with the idler gear 8 of the first countershaft w_v1. Using the intermediate gear ZR, a reversal of rotation can be realized for implementing the reverse gear transmission ratios. In the first and fourth variant embodiments, in the second gear plane 9-2 as a single gear plane, the fixed gear 2 of the second transmission input shaft w_k2 meshes with the idler gear 9 of the first countershaft w_v1, and in the third gear plane 3-13 as a single gear plane, the fixed gear 3 of the second transmission input shaft w_k2 meshes with the idler gear 13 of the second countershaft w_v2.

According to the first variant embodiment, in the fourth gear plane 10-14 as a dual gear plane, the fixed gear 4 of the first transmission input shaft w_k1 meshes both with the idler gear 10 of the first countershaft w_v1 as well as with the intermediate gear ZR on the intermediate shaft w_zw for the reversal of rotation, wherein the intermediate gear ZR meshes additionally with the idler gear 14 of the second countershaft w_v2. Further, in the fifth gear plane 11-5 as a single gear plane, the fixed gear 5 of the first transmission input shaft w_k1 meshes with the idler gear 11 of the first countershaft w_v1. In the six gear plane 6-15 as a single gear plane, the fixed gear 6 of the first transmission input shaft w_k1 meshes with the idler gear 15 of the second countershaft w_v2.

In contrast, in the fourth variant embodiment, in the fourth gear plane 10-14 as a dual gear plane, the fixed gear 4 of the first transmission input shaft w_k1 meshes with both the idler gear 10 of the first countershaft w_v1 and the idler gear 14 of the second countershaft w_v2. In the fifth gear plane 11-15 as a dual gear plane, the fixed gear 5 of the first transmission input shaft w_k1 meshes both with the idler gear 11 of the first countershaft w_v1 and with the idler gear 15 of the second countershaft w_v2.

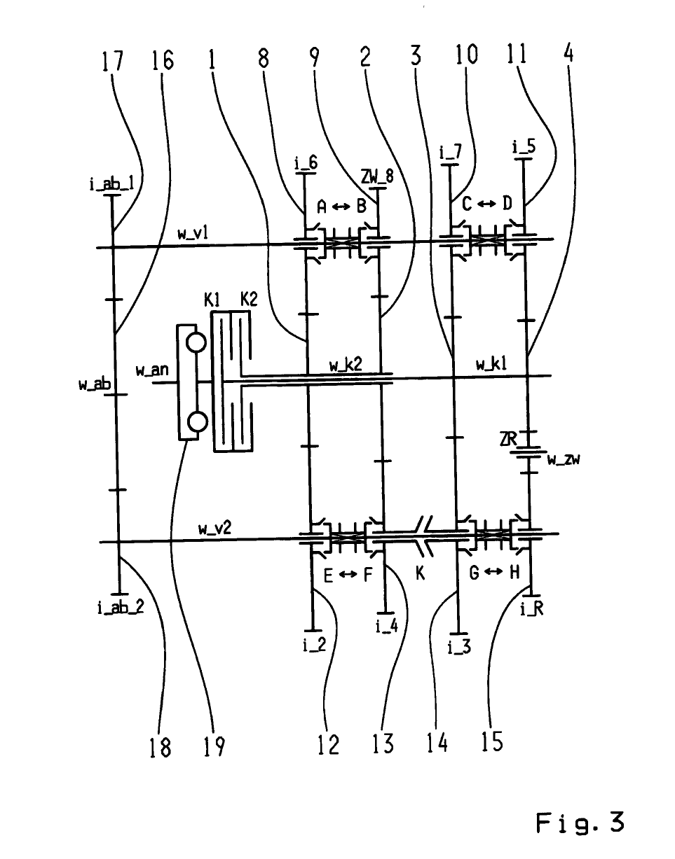

In the second variant embodiment according to FIG. 3, in the first gear plane 8-12 as a dual gear plane, the fixed gear 1 of the second transmission input shaft w_k2 meshes both with the idler gear 8 of the first countershaft w_v1 with the idler gear 12 of the second countershaft w_v2. In the second gear plane 9-13 as a dual gear plane, the fixed gear 2 of the second transmission input shaft w_k2 meshes both with the idler gear 9 of the first countershaft w_v1 with the idler gear 13 of the second countershaft w_v2. In addition, in the third gear plane 10-14 as a dual gear plane, the fixed gear 3 of the first transmission input shaft w_k1 meshes both with the idler gear 10 of the first countershaft w_v1 and the idler gear 14 of the second countershaft w_v2, and in the fourth gear plane 11-15 as a dual gear plane, the fixed gear 4 of the first transmission input shaft w_v1 meshes both with the idler gear 11 of the first countershaft w_v1 and with the intermediate gear ZR on the intermediate shaft w_zw for the reversal of rotation, wherein the intermediate gear ZR meshes additionally with the idler gear 15 of the second countershaft w_v2.

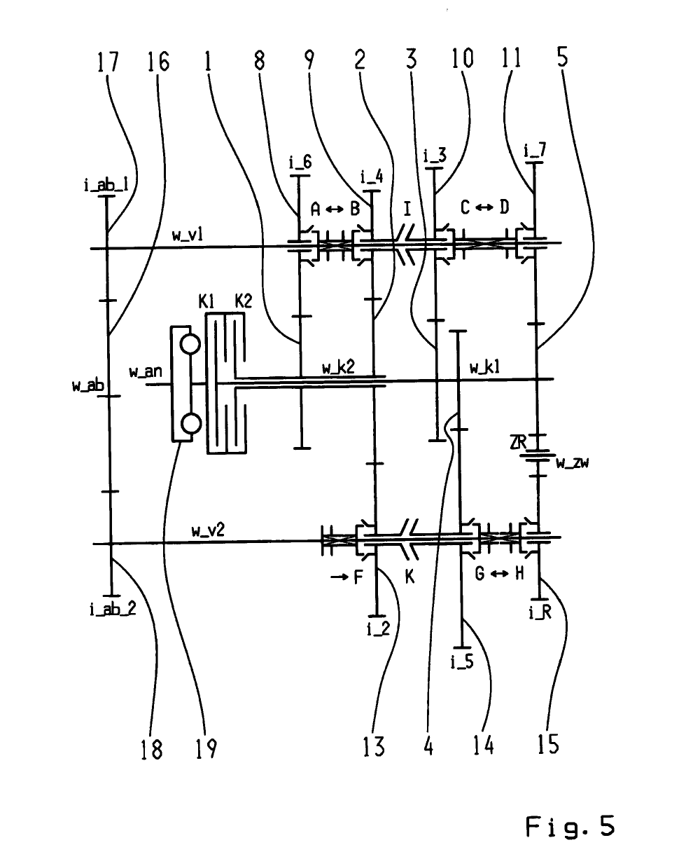

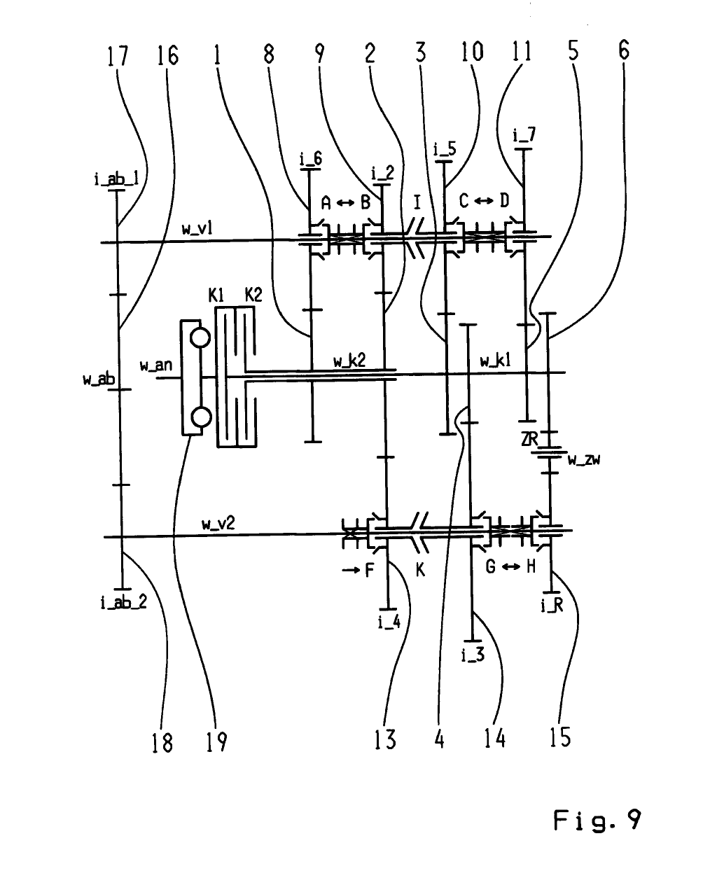

Correspondingly, in the third and fifth variant embodiments according to the FIGS. 5 and 9, in the first gear plane 8-1 as a single gear plane, the fixed gear 1 of the second transmission input shaft w_k2 meshes with the idler gear 8 of the first countershaft w_v1. In the second gear plane 9-13 as a dual gear plane, the fixed gear 2 of the second transmission input shaft w_k2 meshes both with the idler gear 9 of the first countershaft w_v1 and the idler gear 13 of the second countershaft w_v2. In the third gear plane 10-3 as a single gear plane, the fixed gear 3 of the first transmission input shaft w_k1 meshes with the idler gear 10 of the first countershaft w_v1, and in the fourth gear plane 4-14 as a single gear plane, the fixed gear 4 of the first transmission input shaft w_k1 meshes with the idler gear 14 of the second countershaft w_v2. Finally, in the third variant embodiment, in the fifth gear plane 11-15 as a dual gear plane, the fixed gear 5 of the first transmission input shaft w_k1 meshes both with the idler gear 11 of the first countershaft w_v1 and the intermediate gear ZR on the intermediate shaft w_zr for the reversal of rotation, wherein the intermediate gear ZR in turn meshes with the idler gear 15 of the second countershaft w_v2. In contrast, in the fifth variant embodiment, in the fifth gear plane 11-5 as a single gear plane, the fixed gear 5 of the first transmission input shaft w_k1 meshes with the idler gear 11 of the first countershaft w_v1, and in the sixth gear plane 6-15 as a single gear plane, the fixed gear 6 of the first transmission input shaft w_k1 meshes with the intermediate gear ZR on the intermediate shaft w_zw for the reversal of rotation, wherein the intermediate gear ZR in turn meshes with the idler gear 15 of the second countershaft w_v2.

In all variant embodiments, a bidirectionally operative coupling device A-B is provided on the first countershaft w_v1 between the first gear plane 8-12 or 8-1 and the second gear plane 9-2 or 9-12, wherein the activated coupling device A connects the idler gear 8 to the first countershaft w_v1 in a fixed manner, and the activated coupling device B connects the idler gear 9 to the first countershaft w_v1 in a fixed manner. In addition, a bidirectionally operative coupling device C-D is disposed on the first countershaft between the third gear plane 10-14, 10-3 or fourth gear plane 10-14 and the fourth gear plane 11-15 or fifth gear plane 11-5, 11-15, wherein the activated coupling device C connects the idler gear 10 to the first countershaft w_v1 in a fixed manner, and wherein the activated coupling device D connects the idler gear 11 to the first countershaft w_v1 in a manner.

In the first, second, third, and fifth variant embodiments according to the FIGS. 1, 3, 5 and 9, a bidirectionally operative coupling device G-H is provided on the second countershaft w_v2 between the third gear plane 10-14 or fourth gear plane 10-14, 4-14 and the fourth gear plane 11-15 or fifth gear plane 11-15 or sixth gear plane 6-15, wherein the activated coupling device G connects the idler gear 14 to the second countershaft w_v2 in a fixed manner, and wherein the activated coupling device H connects the idler gear 15 to the second countershaft w_v2 in a fixed manner.

In addition in the first, second and fourth variant embodiments according to the FIGS. 1, 3 and 7, a bidirectionally operative coupling device E-F is disposed between the first gear plane 8-12 and the second gear plane 9-13 or third gear plane 3-13, wherein the activated coupling device E connects the idler gear 12 to the second countershaft w_v2 in a fixed manner, and wherein the activated coupling device F connects the idler gear 13 to the second countershaft w_v2 in a fixed manner.

In the third and fifth variant embodiments according to the FIGS. 5 and 9, a unidirectionally operative coupling device F on the second countershaft w_v2 is assigned to the second gear plane, wherein the activated coupling device F connects the idler gear 13 to the second countershaft w_v2 in a fixed manner.

Finally, in the fourth variant embodiment according to FIG. 7, a unidirectionally operative coupling device H on the second countershaft w_v2 is assigned to the fifth gear plane 11-15, wherein the activated coupling device H connects the idler gear 15 to the second countershaft w_v2 in a fixed manner.

In the double clutch transmission according to the invention, an integrated output stage is provided as the output gear 17, which is connected to the first countershaft w_v1 in a rotationally fixed manner, and to the output gear 18, which is disposed on the second countershaft w_v2. The output gear 17 and the output gear 18 each mesh with a fixed gear 16 of the output shaft w_ab. However, it is also possible that a shiftable connection is implemented between the output gear 17 or 18 and the associated countershaft w_v1 or w_v2 by a shiftable coupling device S_ab1 or S_ab2. For example, the coupling device S_ab1 can be assigned to the output gear 17, and the coupling device S_ab2 can be assigned to the output gear 18.

Independent of the respective variant embodiment, with the double clutch transmission according to the invention it is feasible that at least the forward gears G1 to G7 are power shiftable. Depending on the variant embodiment, additionally, reverse gears, crawler gears and/or overdrive gears can also be implemented power shiftable as winding path gears. Details for each variant embodiment arise from the shifting patterns described in the following.

The table in FIG. 2 shows an example of a shift pattern for the first variant embodiment of the eight-speed double clutch transmission according to FIG. 1.

It can be seen from the shifting pattern that the first forward gear G1 can be shifted as a winding path gear using the first clutch K1 and using the activated coupling device F as well as the activated shifting element I, that the second forward gear G2 can be shifted using the second clutch K2 and using the activated coupling device F, that the third forward gear G3 can be shifted using the first clutch K1 and using the activated coupling device C, that the fourth forward gear G4 can be shifted using the second clutch K2 and using the activated coupling device B, that the fifth forward gear G5 can be shifted using the first clutch K1 and using the activated coupling device D, that the sixth forward gear G6 can be shifted using the second clutch K2 and using the activated coupling device E, that the seventh forward gear G7 can be shifted using the first clutch K1 and using the activated coupling device H, and that the eighth forward gear G8 can be shifted as a winding path gear using the first clutch K1 and using the activated coupling device A as well as using the activated shift element I.

With the first variant embodiment, it can further be seen from the table in FIG. 2, that a reverse gear R1 can be shifted using the first clutch K1 and using the activated coupling device G. A next reverse gear R2 can be shifted as a winding path gear using the second clutch K2, using the activated coupling device B, using the activated coupling device D, and using the activated coupling device G, and with the coupling device S_ab1 disengaged. Beyond that, a further reverse gear R3 can be shifted as a winding path gear using the first clutch K1, using the activated coupling device B, using the activated coupling device E, and using the activated coupling device G, and with the coupling device S_ab2 disengaged.

Furthermore, with the proposed double clutch transmission according to the first variant embodiment, a crawler gear C1 can be shifted as a winding path gear using the second clutch K2, using the activated coupling device C, using the activated coupling device F and using the activated coupling device H, and with the coupling device S_ab2 disengaged. In addition, a crawler gear C2 can be shifted as a winding path gear using the second clutch K2, using the activated coupling device D, using the activated coupling device F, and using the activated coupling device H, and with the coupling device S_ab2 disengaged.

Further, the first variant embodiment results in that an overdrive O1 can be shifted as a winding path gear using the second clutch K2 and using the activated coupling device H as well as the activated coupling device I. In addition, an overdrive gear O2 can be shifted as a winding path gear using the first clutch K1, using the activated coupling device B, using the activated coupling device F, and using the activated coupling device H, and with the coupling device S_ab2 disengaged.

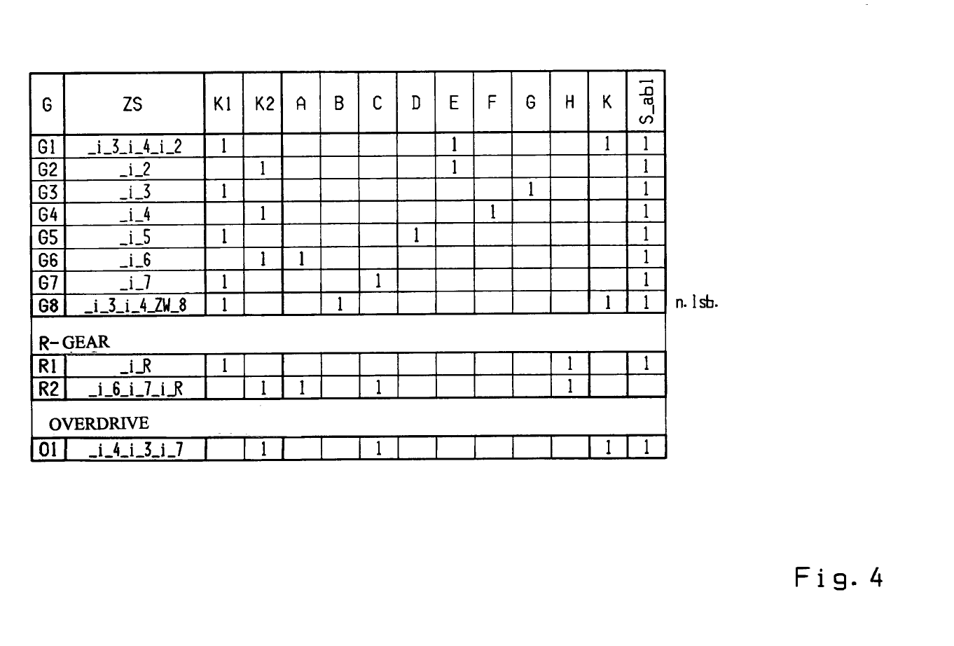

The table in FIG. 4 shows an example of a shift pattern for the second variant embodiment of the eight-speed double clutch transmission according to FIG. 3.

It can be seen from the shifting pattern that the first forward gear G1 can be shifted as a winding path gear using the first clutch K1 and using the activated coupling device E as well as the activated shifting element K, that the second forward gear G2 can be shifted using the second clutch K2 and using the activated coupling device E, that the third forward gear G3 can be shifted using the first clutch K1 and using the activated coupling device G, that the fourth forward gear G4 can be shifted using the second clutch K2 and using the activated coupling device F, that the fifth forward gear G5 can be shifted using the first clutch K1 and using the activated coupling device D, that the sixth forward gear G6 can be shifted using the second clutch K2 and using the activated coupling device A, that the seventh forward gear G7 can be shifted using the first clutch K1 and using the activated coupling device C, and that the eighth forward gear G8 can be shifted as a winding path gear using the first clutch K1 and using the activated coupling device B as well as using the activated shift element K.

With the second variant embodiment, it can further be seen from the table in FIG. 4, that a reverse gear R1 can be shifted using the first clutch K1 and using the activated coupling device H. In addition, a further reverse gear R2, for example, can be shifted as a winding path gear using the second clutch K2, using the activated coupling device A, using the activated coupling device C, and using the activated coupling device H, and with the coupling device S_ab1 disengaged.

In addition, an overdrive gear O1 can be shifted as a winding path gear using the second clutch K2 and using the activated coupling device C, as well as using the activated shift element K.

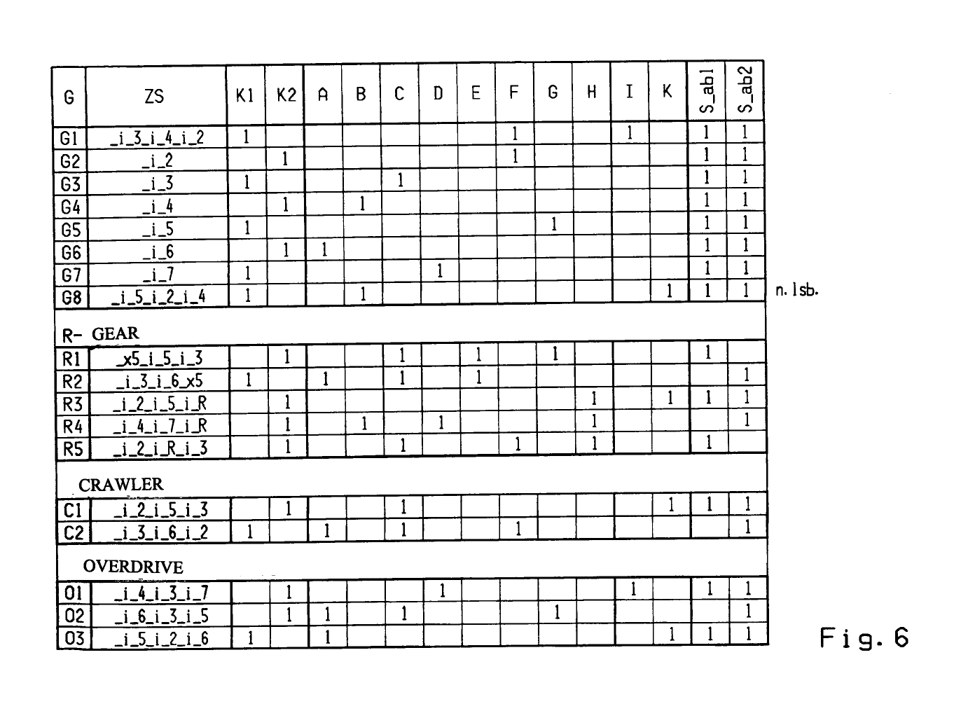

The table in FIG. 6 shows an example of a shift pattern for the third variant embodiment of the eight-speed double clutch transmission according to FIG. 5.

It can be seen from the shifting pattern that the first forward gear G1 can be shifted as a winding path gear using the first clutch K1 and using the activated coupling device F as well as the activated shifting element I, that the second forward gear G2 can be shifted using the second clutch K2 and using the activated coupling device F, that the third forward gear G3 can be shifted using the first clutch K1 and using the activated coupling device C, that the fourth forward gear G4 can be shifted using the second clutch K2 and using the activated coupling device B, that the fifth forward gear G5 can be shifted using the first clutch K1 and using the activated coupling device G, that the sixth forward gear G6 can be shifted using the second clutch K2 and using the activated coupling device A, that the seventh forward gear G7 can be shifted using the first clutch K1 and using the activated coupling device D, and that the eighth forward gear G8 can be shifted as a winding path gear using the first clutch K1 and using the activated coupling device B as well as using the activated shift element K.

In the third variant embodiment it can further be seen from the table represented in FIG. 6 that a reverse gear R1 can be shifted as a winding path gear using the second clutch K2, using the activated coupling device C, using the activated coupling device E and using the activated coupling device G, and with the coupling device S_ab2 disengaged. In addition, a reverse gear R2 can be shifted as a winding path gear using the first clutch K1, using the activated coupling device A, using the activated coupling device C, and using the activated coupling device E, and with the coupling device S_ab1 disengaged. A next reverse gear R3 can be shifted as a winding path gear using the second clutch K2 and using the activated coupling device H as well as using the activated shift element K. In addition, a reverse gear R4 can be shifted as a winding path gear using the second clutch K2, using the activated coupling device B, using the activated coupling device D, and using the activated coupling device H, and with the coupling device S_ab1 disengaged. Finally, a further reverse gear R5 can be shifted as a winding path gear using the second clutch K2, using the activated coupling device C, using the activated coupling device F, and using the activated coupling device H, and with the coupling device S_ab2 disengaged.

Furthermore, a crawler gear C1 can be shifted as a winding path gear using the second clutch K2 and using the activated coupling device C, as well as using the activated shift element K. In addition, a crawler gear C2 can be shifted as a winding path gear using the first clutch K1, using the activated coupling device A, using the activated coupling device C, and using the activated coupling device F, and with the coupling device S_ab1 disengaged.

Further, an overdrive gear O1 can be shifted as a winding path gear using the second clutch K2 and using the activated coupling device D, as well as using the activated shift element I. Beyond that, an overdrive gear O2 can be shifted as a winding path gear using the second clutch K2, using the activated coupling device A, using the activated coupling device C, and using the activated coupling device G, and with the coupling device S_ab1 disengaged. Finally, an overdrive gear O3 can be shifted as a winding path gear using the first clutch K1 and using the activated coupling device A, as well as using the activated shift element K.

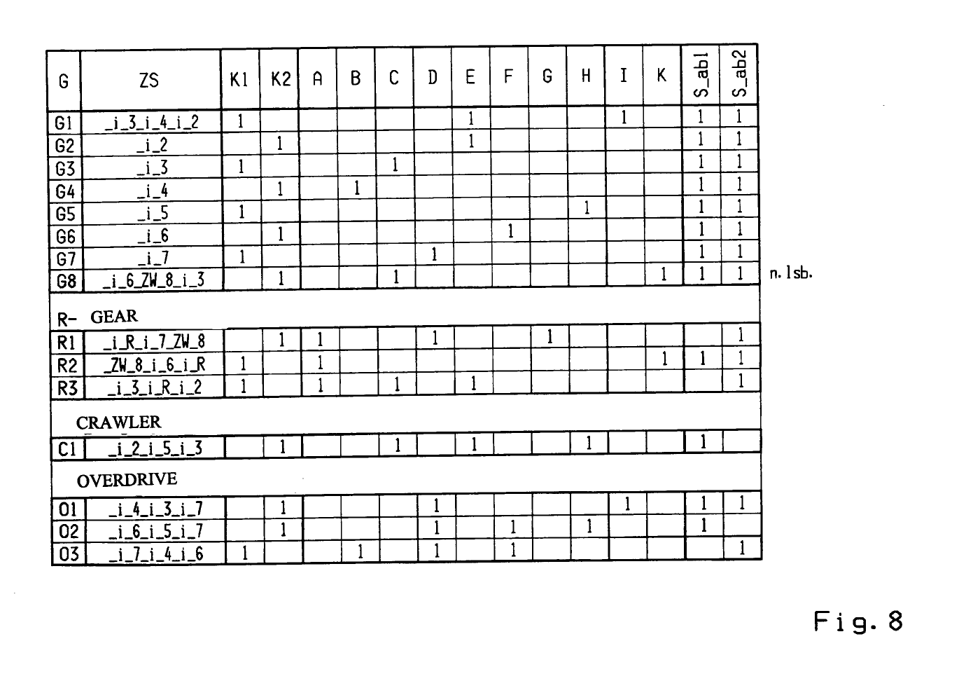

The table in FIG. 8 shows an example of a shift pattern for the fourth variant embodiment of the eight-speed double clutch transmission according to FIG. 7.

It can be seen from the shifting pattern that the first forward gear G1 can be shifted as a winding path gear using the first clutch K1 and using the activated coupling device E as well as the activated shifting element I, that the second forward gear G2 can be shifted using the second clutch K2 and using the activated coupling device E, that the third forward gear G3 can be shifted using the first clutch K1 and using the activated coupling device C, that the fourth forward gear G4 can be shifted using the second clutch K2 and using the activated coupling device B, that the fifth forward gear G5 can be shifted using the first clutch K1 and using the activated coupling device H, that the sixth forward gear G6 can be shifted using the second clutch K2 and using the activated coupling device F, that the seventh forward gear G7 can be shifted using the first clutch K1 and using the activated coupling device D, and that the eighth forward gear G8 can be shifted as a winding path gear using the second clutch K2 and using the activated coupling device C as well as using the activated shift element K.

With the fourth variant embodiment, it can be seen further from the table in FIG. 8, that a reverse gear R1 can be shifted as a winding path gear using the second clutch K2, using the activated coupling device A, using activated coupling device D and using the activated coupling device G, and with the coupling device S_ab1 disengaged, and/or that a further reverse gear R2 can be shifted as a winding path gear using the first clutch K1 and using the activated coupling device A as well as the activated shift element K. In addition, a reverse gear R3 can be shifted as a winding path gear using the first clutch K1, using the activated coupling device A, using the activated coupling device C, and using the activated coupling device E, and with the coupling device S_ab1 disengaged.

Furthermore, with the proposed double clutch transmission according to the fourth variant embodiment, a crawler gear C1 can be shifted as a winding path gear using the second clutch K2, using the activated coupling device C, using the activated coupling device E and using the activated coupling device H, and with the coupling device S_ab2 disengaged.

Further, an overdrive gear O1 can be shifted as a winding path gear using the second clutch K2 and using the activated coupling device D, as well as using the activated shift element I. In addition, an overdrive gear O2 can be shifted as a winding path gear using the second clutch K2, using the activated coupling device D, using the activated coupling device F, and using the activated coupling device H, and with the coupling device S_ab2 disengaged. Finally, an overdrive gear O3 can be shifted as a winding path gear using the first clutch K1, using the activated coupling device B, using the activated coupling device D, and using the activated coupling device F, and with the coupling device S_ab1 disengaged.

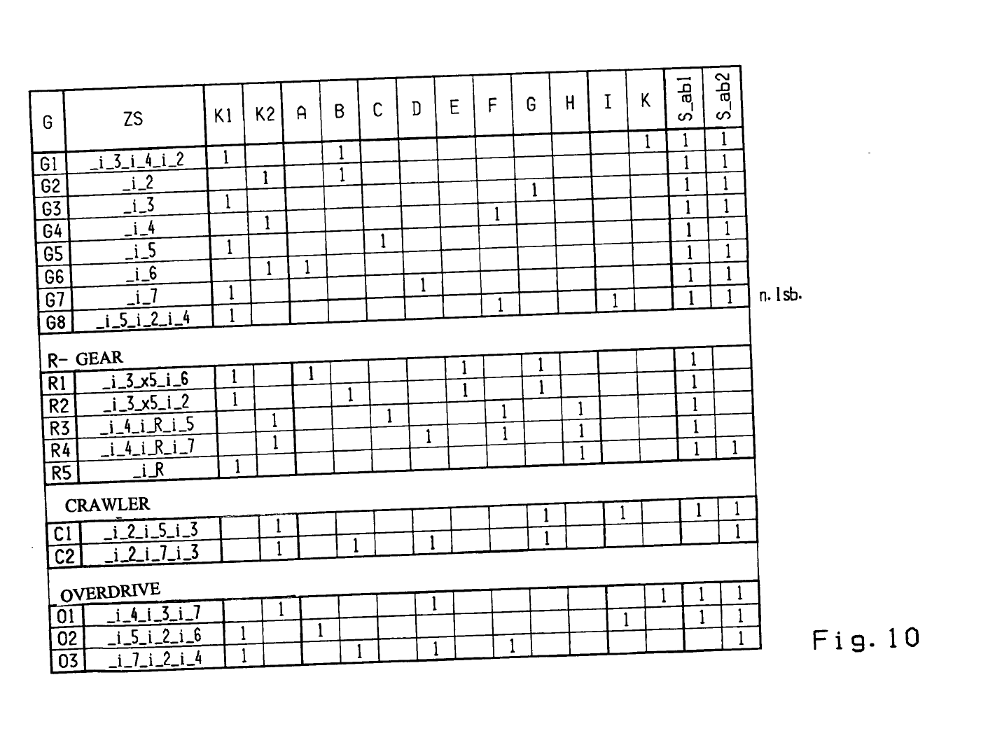

The table in FIG. 10 shows an example of a shift pattern for the fifth variant embodiment of the eight-speed double clutch transmission according to FIG. 9.

It can be seen from the shifting pattern that the first forward gear G1 can be shifted as a winding path gear using the first clutch K1 and using the activated coupling device B as well as the activated shifting element K, that the second forward gear G2 can be shifted using the second clutch K2 and using the activated coupling device B, that the third forward gear G3 can be shifted using the first clutch K1 and using the activated coupling device G, that the fourth forward gear G4 can be shifted using the second clutch K2 and using the activated coupling device F, that the fifth forward gear G5 can be shifted using the first clutch K1 and using the activated coupling device C, that the sixth forward gear G6 can be shifted using the second clutch K2 and using the activated coupling device A, that the seventh forward gear G7 can be shifted using the first clutch K1 and using the activated coupling device D, and that the eighth forward gear G8 can be shifted as a winding path gear using the first clutch K1 and using the activated coupling device F as well as using the activated shift element I.

In the fourth variant embodiment it can further be seen from the table represented in FIG. 10 that a reverse gear R1 can be shifted as a winding path gear using the first clutch K1, using the activated coupling device A, using the activated coupling device E and using the activated coupling device G, and with the coupling device S_ab2 disengaged. Beyond that, a further reverse gear R2 can be shifted as a winding path gear using the first clutch K1, using the activated coupling device B, using the activated coupling device E, and using the activated coupling device G, and with the coupling device S_ab2 disengaged. In addition, a reverse gear R3 can be shifted as a winding path gear using the second clutch K2, using the activated coupling device C, using the activated coupling device F, and using the activated coupling device H, and with the coupling device S_ab2 disengaged. Further, a reverse gear R4 can be shifted as a winding path gear using the second clutch K2, using the activated coupling device D, using the activated coupling device F, and using the activated coupling device H, and with the coupling device S_ab2 disengaged. In addition, a reverse gear R5 can be shifted using the first clutch K1 and using the activated coupling device H.

Furthermore, a crawler gear C1 can be shifted as a winding path gear using the second clutch K2 and using the activated coupling device G, as well as using an activated shift element I. Beyond that, a further crawler gear C2, can be shifted as a winding path gear using the second clutch K2, using the activated coupling device B, using the activated coupling device D, and using the activated coupling device G, and with the coupling device S_ab1 disengaged.

In addition, an overdrive gear O1 can be shifted as a winding path gear using the second clutch K2 and using the activated coupling device D, as well as using the activated shift element K. An overdrive gear O2 can be shifted as a winding path gear using the first clutch K1 and using the activated coupling device A, as well as using the activated shift element I. Finally, an overdrive gear O3 can be shifted as a winding path gear using the first clutch K1, using the activated coupling device B, using the activated coupling device D, and using the activated coupling device F, and with the coupling device S_ab1 disengaged.

From the shift pattern according to FIG. 2, it can be seen in detail that for the first forward gear G1, based on the first clutch K1, the gear stages i_3, i_4 and i_2 are used, wherein the shift element I is activated for coupling of both subtransmissions. For the second forward gear G2, the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, and for the seventh forward gear G7, the gear stage i_7 is used. For the eighth forward gear G8, based on the first clutch K1, the gear steps, or gear stages, i_3, i_4 and ZW_8 are used, in the first variant embodiment, the two subtransmissions are coupled using the shift element I.

In addition, for the reverse gear R1, the gear stage i_R is used. Furthermore, for the further reverse gear R2, based on the second clutch K2, the gear stages i_4, i_5 and i_R are used, with the coupling device S_ab1 being disengaged for coupling the two subtransmissions. Beyond that, for the next reverse gear R3, based on the first clutch K1, the gear stages i_R, i_6 and i₄ 4 are used, the coupling device S_ab2 being disengaged for coupling the two subtransmissions. For the crawler gear C1, based on the second clutch K2, the gear stages i_2, i_7 and i_3 are used, with the two subtransmissions being coupled with the coupling device S_ab2 disengaged. For the crawler gear C2, based on the second clutch K2, the gear stages i_2, i_7 and i_5 are used, with the two subtransmissions being coupled with the coupling device S_ab2 disengaged. For the overdrive gear O1, based on the second clutch K2, the gear stages i_4, i_3 and i_7 are used, with the two subtransmissions being coupled using the activated shift element I. For the overview gear O2, based on the first clutch K1, the gear stages i_7, i_2 and i_4 are used, with the two subtransmissions being coupled with the coupling device S_ab2 disengaged.

From the shift pattern according to FIG. 4 it can be seen in detail that for the first forward gear G1, based on the first clutch K1, the gear stages i_3, i_4 and i_2 are used, and the two subtransmissions are coupled together using the activated shift element K. For the second forward gear G2, the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, and for the seventh forward gear G7, the gear stage i_7 is used. For the eighth forward gear G8, based on the first clutch K1, the gear stages i_3, i_4, and ZW_8 are used, and the shift element K is activated for coupling the two subtransmissions. In addition, based on the first clutch K1, the gear stage i_R is used for the reverse gear R1. Furthermore, for the additional reverse gear R2, based on the second clutch K2, the gear stages i_6, i_7 and i_R are used, wherein the two subtransmissions are coupled with the coupling device S_ab1 disengaged. Finally, for the overdrive gear O1, based on the second clutch K2, the gear stages i_4, i_3 and i_7 are used, wherein the two subtransmissions are coupled using the activated shift element K.

From the shift pattern according to FIG. 6 it can be seen in detail that for the first forward gear G1, based on the first clutch K1, the gear stages i_3, i_4 and i_2 are used, and the two subtransmissions are coupled together using the activated shift element I. For the second forward gear G2, the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, and for the seventh forward gear G7, the gear stage i_7 is used. For the eighth forward gear G8, based on the first clutch K1, the gear stages, i_5, i_2 and i_4 are used, and the two subtransmissions are coupled together via the activated shift element K. In addition, for the reverse gear R1, based on the second clutch K2, the gear stages x_5, i_5 and i_3 are used, and the two subtransmissions are coupled with the coupling device S_ab2 disengaged. For the reverse gear R2, based on the first clutch K1, the gear stages i_3, i_6 and x_5 are used, wherein for the reverse gear R2, the two subtransmissions are coupled with the coupling device S_ab1 disengaged. For the reverse gear R3, based on the second clutch K2, the gear stages i_2, i_5 and i_R are used, and the two subtransmissions are coupled using the activated shift element K. In addition, for the reverse gear R4, based on the second clutch K2, the gear stages i_4, i_7 and i_R are used, and the two subtransmissions are coupled with the coupling device S_ab1 disengaged. In addition, for the reverse gear R5, based on the second clutch K2, the gear stages i_2, i_R and i_3 are used, and the two subtransmissions are coupled together with the coupling device S_ab2 disengaged. In addition, for the crawler gear C1, based on the second clutch K2, the gear stages i_2, i_5 and i_3 are used, and the two subtransmissions are coupled using the shift element K. For the crawler gear C2, based on the first clutch K1, the gear stages i_3, i_6 and i_2 are used, and the subtransmissions are coupled with the coupling device S_ab1 disengaged. Finally, for the overdrive gear O1, based on the second clutch K2, the gear stages i_4, i_3 and i_7 are used, and the two subtransmissions are coupled using the activated shift element I. For the overdrive gear O2, based on the second clutch K2, the gear stages i_6, i_3 and i_5 are used, and the subtransmissions are coupled with the coupling device S_ab1 disengaged. Finally, for the overdrive gear O3, based on the first clutch K1, the gear stages i_5, i_2 and i_6 are used, wherein the two subtransmissions are coupled using the activated shift element K.

From the shift pattern according to FIG. 8 it can be seen in detail that for the first forward gear G1, based on the first clutch K1, the gear stages i_3, i_4 and i_2 are used, and the two subtransmissions are coupled using the activated shift element I. For the second forward gear G2, the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, and for the seventh forward gear G7, the gear stage i_7 is used. For the eighth forward gear G8, based on the second clutch K2, the gear stages i_6, ZW_8 and i_3 are used, wherein the two subtransmissions are coupled using the activated shift element K. In addition, for the reverse gear R1, based on the second clutch K2, the gear stages i_R, i_7 and ZW_8 are used, and the two subtransmissions are coupled with the coupling device S_ab1 disengaged. For the further reverse gear R2, based on the first clutch K1, the gear stages ZW_8, i_6 and i_R are used, and the two subtransmissions are coupled using the shift element K. For the further reverse gear R3, based on the first clutch K1, the gear stages i_3, i_R and i_2 are used, and the two subtransmissions are coupled together with the coupling device S_ab1 disengaged. For the crawler gear C1, based on the second clutch K2, the gear stages i_2, i_5 and i_3 are used, and the two subtransmissions are coupled with the coupling device S_ab2 disengaged. In addition, for the overdrive gear O1, based on the second clutch K2, the gear stages i_4, i_3 and i_7 are used, and the two subtransmissions are coupled together using the shift element I. For the overdrive gear O2, based on the second clutch K2, the gear stages i_6, i_5 and i_7 are used, and the two subtransmissions are coupled with the coupling device S_ab2 disengaged. Finally, for the overdrive gear O3, based on the first clutch K1, the gear stages i_7, i_4 and i_6 are used, and the subtransmissions are coupled with the coupling device S_ab1 disengaged.

From the shift pattern according to FIG. 10 it can be seen in detail that for the first forward gear G1, based on the first clutch K1, the gear stages i_3, i_4 and i_2 are used, and the two subtransmissions are coupled using the activated shift element K. For the second forward gear G2, the gear stage i_2 is used, for the third forward gear G3, the gear stage i_3 is used, for the fourth forward gear G4, the gear stage i_4 is used, for the fifth forward gear G5, the gear stage i_5 is used, for the sixth forward gear G6, the gear stage i_6 is used, and for the seventh forward gear G7, the gear stage i_7 is used. For the eighth forward gear G8, the gear stages i_5, i_2 and i_4 are used, and the subtransmission are coupled using the activated shift element I. In addition, for the reverse gear R1, based on the first clutch K1, the gear stages i_3, x_5 and i_6 are used, and the subtransmissions are coupled with the coupling device S_ab2 disengaged. For the further reverse gear R2, based on the first clutch K1, the gear stages i_3, x_5 and i_2 are used, and the subtransmissions are coupled with the coupling device S_ab2 disengaged. In the next reverse gear R3, based on the second clutch K2, the gear stages i_4, i_R and i_5 are used, and the two subtransmissions are coupled together with the coupling device S_ab2 disengaged. For the reverse gear R4, based on the second clutch K2, the gear stages i_4, i_R and i_7 are used, and the two subtransmissions are coupled together with the coupling device S_ab2 disengaged. Finally, for the reverse gear R5, based on the first clutch K1, the gear stage i_R is used.

For the crawler gear C1, based on the second clutch K2, the gear stages i_2, i_5 and i_3 are used, and the two subtransmissions are coupled together using the shift element I. In addition, for the next crawler gear C2, based on the second clutch K2, the gear stages i_2, i_7 and i_3 are used, and the two subtransmissions are coupled with the coupling device S_ab1 disengaged. For the overdrive gear O1, based on the second clutch K2, the gear stages i_4, i_3 and i_7 are used, and the two subtransmissions are coupled together using an activated shift element K. In addition, for the overdrive gear O2, based on the first clutch K1, the gear stages i_5, i_2 and i_6 are used, and the two subtransmissions are coupled together using the shift element I. Finally, for the overdrive gear O3, based on the first clutch K1, the gear stages i_7, i_2 and i_4 are used, and the subtransmissions are coupled together with the coupling device S_ab1 disengaged.

In summary, with the first variant embodiment according to FIGS. 1 and 2, with the two dual gear planes and four single gear planes, as well as one winding path shift element I, a good adjustability of the stages of the lower gears results due to the arrangement of the gear stages i_2, and i_4, each on a single gear plane.

In detail, for the first variant embodiment it can be seen that on the first gear plane 8-12 as a dual gear plane, the idler gear 8 is used for a forward gear G8 and the idler gear 12 is used for a forward gear G6 as well as for one reverse gear R3. On the second gear plane 9-2 as a single gear plane, the idler gear 9 is used for five forward gears G1, G4, G8, O1, O2 and two reverse gears R2, R3. On the third gear plane 3-13 as a single gear plane, the idler gear 13 is used for five forward gears G1, G2, C1, C2, O2. On the fourth gear plane 10-14 as a dual gear plane, the idler gear 10 is used for five forward gears G1, G3, G8, C1, O1, and the idler gear 14 is used for three reverse gears R1, R2, R3. On the fifth gear plane 11-5 as a single gear plane, the idler gear 11 is used for two forward gears G5, C2 as well as for one reverse gear R2. Finally, on the sixth gear plane 6-15 as a single gear plane, the idler gear 15 is used for five forward gears G7, C1, C2, O1, O2.

In summary, with the second variant embodiment according to FIGS. 3 and 4, with four dual gear planes and one winding path-shift element K, a favorable shaft and bearing design results because the first countershaft w_v1 with the gear stages i_5, i_6, i_7 and the additional gear stage ZW_8, which is not used for other forward gears, is less loaded.

In detail, the second variant embodiment results in that on the first gear plane 8-12 as a dual gear plane, the idler gear 8 is used for a forward gear G6 as well as a reverse gear R2 and the idler gear 12 is used for two forward gears G1, G2. On the second gear plane 9-13 as a dual gear plane, the idler gear 9 is used for a forward gear G8, and the idler gear 13 is used for four forward gears G1, G4, G8, O1. On the third gear plane 10-14 as a dual gear plane, the idler gear 10 is used for two forward gears G7, O1 as well as for one reverse gear R2, and the idler gear 14 is used for four forward gears G1, G3, G8, O1. On the fourth gear plane 11-15 as a dual gear plane, the idler gear 11 is used for one forward gear G5, and the idler gear 15 is used for two reverse gears R1, R2.

In summary, for the third variant embodiment according to the FIGS. 5 and 6, a good staging results with only low construction cost, with the two winding path gear-shift elements I and K, as well as the two dual gear planes, and three single gear planes. In addition, a further overdrive gear O3 leads to a fuel savings.

In detail, the third variant embodiment results in that on the first gear plane 8-1 as a single gear plane, that the idler gear 8 is used for four forward gears G6, C2, O2, O3 as well as for a reverse gear R2. On the second gear plane 9-13 as a dual gear plane, the idler gear 9 is used for four forward gears G1, G4, G8, O1 as well as for a reverse gear R4, and the idler gear 13 is used for six forward gears G1, G2, G8, C1, C2, O3 as well as for two reverse gear R3, R5. On the third gear plane 10-3 as a single gear plane, the idler gear 10 is used for six forward gears G1, G3, C1, C2, O1, O2 as well as for three reverse gears R1, R2, R5. On the fourth gear plane 4-14 as a single gear plane, the idler gear 14 is used for five forward gears G5, G8, C1, O2, O3 as well as for two reverse gears R1, R3. On the fifth gear plane 11-15 as a dual gear plane, the idler gear 11 is used for two forward gears G7, O1 as well as for a reverse gear R4, and the idler gear 15 is used for three reverse gears R3, R4, R5.

In summary, for the fourth variant embodiment according to the FIGS. 7 and 8, with three duel gear planes and two single gear planes, an improved adjustability of the staging results due to the use of the additional gear plane ZW_8, which is used only for one forward gear.

In detail, the fourth variant embodiment results in that on the first gear plane 8-12 as a dual gear plane, the idler gear 8 is used for three reverse gears R1, R2, R3 and the idler gear 12 is used for three forward gears G1, G2, C2 as well as for one reverse gear R3. On the second gear plane 9-2 as a single gear plane, the idler gear 9 is used for four forward gears G1, G4, O1, O3. On the third gear plane 3-13 as a single gear plane, the idler gear 13 is used for four forward gears G6, G8, O2, O3 as well as for a reverse gear R2. On the fourth gear plane 10-14 as a dual gear plane, the idler gear 10 is used for five forward gears G1, G3, G8, C1, O1, as well as for a reverse gear R3, and the idler gear 14 is used for one forward gear G8 as well as two reverse gears R1, R2. On the fifth gear plane 11-15 as a dual gear plane, the idler gear 11 is used for four forward gears G7, O1, O2, O3 as well as for a reverse gear R1, and the idler gear 15 is used for three forward gears G5, C1, O2.

In summary with the fifth variant embodiment according to the FIGS. 9 and 10 with one dual gear plane and five single gear planes, a staging results which can be particularly well adapted, because only two gear stages (i_2 and i_4) are dependent on each other.

In detail, the fifth variant embodiment results in that on the first gear plane 8-1 as a single gear plane, the idler gear 8 is used for two forward gears G6, O2 as well as for a reverse gear R1. On the second gear plane 9-13 as a dual gear plane, the idler gear 9 is used for seven forward gears G1, G2, G8, C1, C2, O2, O3, as well as for a reverse gear R2, and the idler gear 13 is used for five forward gears G1, G4, G8, O1, O3 as well as two reverse gears R3, R4. On the third gear plane 10-3 as a single gear plane, the idler gear 10 is used for four forward gears G5, G8, C1, O2 as well as for a reverse gear R3. On the fourth gear plane 4-14 as a single gear plane, the idler gear 14 is used for five forward gears G1, G3, C1, C2, O1 as well as for two reverse gears R1, R2. On the fifth gear plane 11-5 as a single gear plane, the idler gear 11 is used for four forward gears G7, C2, O1, O3 as well as for a reverse gear R4. Finally, on the sixth gear plane 6-15 as a single gear plane, the idler gear 15 is used for three reverse gears R3, R4, R5.

It is possible with one or also with several variant embodiments that at least one additional gear stage ZW_x (e.g., ZW_8), which is not used in a direct forward gear, is used for winding path gears. The use of an additional gear stage results in the respective Figures of the variant embodiments.

Also, gears x1, x2, . . . x7, x8 can be used for additional winding path gears, which can be added supplementary to a single gear plane, wherein the consecutive numbering of the gears x1, x2, . . . x7, x8 is carried out as follows. The consecutive numbering begins with the first gear x1 of the first countershaft w_v1, based on the associated output stage i_ab_1, continuing up to the fourth gear x4, wherein the first gear on the second countershaft w_v2, based on the associated output stage i_ab_2, is labeled with x5, and the further gears are labeled consecutively up to x8. If the additional gear x1, x2, . . . x7, x8 is used in the context of a reverse gear transmission ratio, a reversal of rotation must occur, for example through the use of an intermediate gear ZR on the intermediate shaft w_zw or similar.

With all variant embodiments of the double clutch transmission, due to these multiple uses of individual idler gears that are provided, fewer gear planes, and thus fewer components are necessary for the same number of gears, resulting in advantageous cost savings and construction space savings.

Independent of the respective variant embodiment, the number “1” in a field of the respective table of the shift pattern according to the FIGS. 2, 4, 6, 8 and 10, indicates that the associated clutch K1, K2, or the associated coupling device A, B, C, D, E, F, G, H, or the associated shift element I, K, in each case, is engaged or activated. In contrast, a blank field in the respective table of the shift pattern according to the FIGS. 2, 4, 6, 8 and 10, indicates that the associated clutch K1, K2, or the associated coupling device A, B, C, D, E, F, G, H, or the associated shift element I, K, in each case, is disengaged.

For the coupling device S_ab1 or S_ab2 assigned to an output gear 17 or 18, respectfully, deviating from the previously stated rules, where there is a blank field in the respective table of the switching patterns according to the FIGS. 2, 4, 6, 8, and 10, this indicates that the coupling device S_ab1 or S_ab2 must be disengaged, and when there is a number “1” in the respective table of the shift pattern according to the FIGS. 2, 4, 6, 8, and 10, that indicates the coupling device S_ab1 or S_ab2 should be engaged. Depending on the gear, the coupling element S_ab1 or S_ab2, must be engaged even for a group of gears, where there is a field with the number “1”, whereas in contrast, for a different group of gears where there is a field with the number “1”, the coupling element S_ab1 or S_ab2 may be either disengaged or engaged.

Furthermore, in many cases the possibility exists to insert further coupling or shift elements, without influencing the flow of power. As a result of this, gear preselection is enabled.

### REFERENCE CHARACTERS

1 Fixed gear of the second transmission input shaft
2 Fixed gear of the second transmission input shaft
3 Fixed gear of the second transmission input shaft
4 Fixed gear of the first transmission input shaft
5 Fixed gear of the first transmission input shaft
6 Fixed gear of the first transmission input shaft
8 Idler gear of the first countershaft
9 Idler gear of the first countershaft
10 Idler gear of the first countershaft
11 Idler gear of the first countershaft
12 Idler gear of the first countershaft
13 Idler gear of the second countershaft
14 Idler gear of the second countershaft
15 Idler gear of the second countershaft
16 Fixed gear of the output shaft
17 Output gear of the first countershaft
18 Output gear of the first countershaft
19 Torsional vibration damper
K1 First clutch
K2 Second clutch
w_an Drive shaft
w_ab Output shaft
w_v1 First countershaft
w_v2 Second countershaft
w_k1 First transmission input shaft
w_k2 Second transmission input shaft
A Coupling device
B Coupling device
C Coupling device
D Coupling device
E Coupling device
F Coupling device
G Coupling device
H Coupling device
i_2 Gear stage second forward gear
i_3 Gear stage third forward gear
_4 Gear stage fourth forward gear
i_5 Gear stage fifth forward gear
i_6 Gear stage sixth forward gear
i_7 Gear stage seventh forward gear
ZW_8 Additional gear stage for winding path gears
x5 Gear for additional winding path gears
i_ab_1 Output stage on the first countershaft
i_ab_2 Output stage on the first countershaft
G1 First forward gear
G2 Second forward gear
G3 Third forward gear
G4 Fourth forward gear
G5 Fifth forward gear
G6 Sixth forward gear
G7 Seventh forward gear
G8 Eighth forward gear
C1 Crawler gear
C2 Crawler gear
O1 Overdrive gear
O2 Overdrive gear
O3 Overdrive gear
R1 Reverse gear
R2 Reverse gear
R3 Reverse gear
R4 Reverse gear
R5 Reverse gear
w_zw Intermediate shaft
ZR Intermediate gear for reversal of rotation
ZS Gear stage used
I Shift element
K Shift element
S_ab1 Coupling device on the output stage optional
S_ab2 Coupling device on the output stage optional
n. Isb. Not power shiftable

1-25. (canceled)

26. A double clutch transmission comprising:
first and second clutches (K1, K2) each comprising an input side connected to a drive shaft (w_an) and an output side respectively connected to one of a first and a second transmission input shaft (w_k1, w_k2) arranged coaxially relative to one another;
at least first and second countershafts (w_v1, w_v2) upon which toothed idler gearwheels (8, 9, 10, 11, 12, 13, 14, 15) are rotatably supported;
toothed fixed gearwheels (1, 2, 3, 4, 5, 6) being supported on the first and the second transmission input shafts (w_k1, w_k2) in a rotationally fixed manner, and each of the fixed gearwheels (1, 2, 3, 4, 5) meshing with at least one of the idler gearwheels (8, 9, 10, 11, 12, 13, 14, 15);
a plurality of coupling devices (A, B, C, D, E, F, G, H) for coupling an idler gearwheel to one of the first and the second countershafts (w_v1, w_v2) in a rotationally fixed manner;
an output gearwheel (17, 18) being provided on each of the first and the second countershafts (w_v1, w_v2), and each of the output gearwheels (17, 18) being coupled to gearing of an output shaft (w_ab);
at least one shift element (I, K) on one of the first and the second countershafts (w_v1, w_v2) for coupling two of the idler gearwheels (8, 9, 10, 11, 12, 13, 14, 15) in a rotationally fixed manner such that at least several power shiftable forward gears (1, 2, 3, 4, 5, 6, 7) and at least one reverse gear (R1, R2, R3, R4, R5) are shiftable; and
a maximum of six gear planes (8-1, 8-12, 9-2, 9-13, 3-13, 10-3, 4-14, 10-14, 11-5, 11-15, 6-15) being provided of which at least one of the gear planes is a dual gear plane (8-12, 9-13, 10-14, 11-15), for each dual gear plane (8-12, 9-13, 10-14, 11-15) at least one idler gearwheel (8, 9, 10, 11, 12, 13, 14, 15) of the first and the second countershafts (w_v1, w_v2) is assigned a fixed gearwheel (1, 2, 3, 4) of one of the first and the second transmission input shafts (w_k1, w_k2), and for each dual gear plane (8-12, 9-13, 10-14, 11-15) at least one idler gearwheel (8, 9, 10, 11, 12, 13, 14, 15) is utilized for at least two gears such that at least one power shiftable winding path gear being shiftable with the at least one shift element (I, K) on one of the first and the second countershafts (w_v1, w_v2).

27. The double clutch transmission according to claim 26, wherein the double clutch transmission has four dual gear planes (8-12, 9-13, 10-14, 11-15).

28. The double clutch transmission according to claim 26, wherein the double clutch transmission has one dual gear plane (9-13) and five single gear planes (8-1, 10-3, 4-14, 11-5, 6-15), and for each of the five single gear planes (8-1, 10-3, 4-14, 11-5, 6-15) an idler gearwheel (8, 10, 11, 14, 15) of the first and the second countershafts (w_v1, w_v2) is assigned a fixed gearwheel (1, 3, 4, 5, 6) of one of the first and the second transmission input shafts (w_K1, w_K2).

29. The double clutch transmission according to claim 26, wherein the double clutch transmission has two dual gear planes (8-12, 10-14; 9-13, 11-15) and at least three single gear planes(8-1, 10-3, 4-14; 9-2, 3-13, 11-5, 6-15), and for each of the at least three single gear planes (8-1, 10-3, 4-14; 9-2, 3-13, 11-5, 6-15) an idler gearwheel (8, 10, 14; 9, 11, 13, 15) of the first and the second countershafts (w_v1, w_v2) is assigned a fixed gearwheel (1, 3, 4; 2, 3, 5, 6) of one of the first and the second transmission input shafts (w_K1, w_K2).

30. The double clutch transmission according to claim 26, wherein the double clutch transmission has three dual gear planes (8-12, 10-14, 11-15) and two single gear planes (9-2, 3-13), and for each of the two single gear planes (9-2, 3-13) an idler gearwheel (9, 13) of the first and the second countershafts (w_v1, w_v2) is assigned a fixed gearwheel (2, 3) of one of the first and the second a transmission input shaft (w_K2).

31. The double clutch transmission according to claim 26, wherein an idler gearwheel (9) of a second subtransmission is connectable to an idler gearwheel (10) of a first subtransmission via the shift element (I) on the first countershaft (w_v1) such that at least one of a first forward gear (G1) and an eighth forward gear (G8) are shiftable as a winding path gear via the shift element (I) on the first countershaft (w_v1).

32. The double clutch transmission according to claim 26, wherein an idler gearwheel (13) of a second subtransmission is connectable to an idler gearwheel (14) of a first subtransmission via the shift element (K) on the second countershaft (w_v2) such that at least one of a first forward gear (G1) and an eighth forward gear (G8) are shiftable as a winding path gear via the shift element (K) on the second countershaft (w_v2).

33. The double clutch transmission according to claim 26, wherein one of a first forward gear (G1), via activation of a first shift element (I), and an eighth forward gear (G8), via activation of a second shift element (K), are shiftable as winding path gears, or the first forward gear (G1), via activation of the second shift element (K) on the second countershaft (w_v2), and the eighth forward gear (G8), via activation of the first shift element (I) on the first countershaft (w_v1) can be shifted as winding path gears.

34. The double clutch transmission according to claim 26, wherein a first gear plane (8-12) is a dual gear plane, and a second gear plane (9-2) and a third gear plane (3-13) are each a single gear plane, and the first gear plane, the second gear plane and the third gear plane respectively comprise three fixed gearwheels (1, 2, 3) on the second transmission input shaft (w_k2) of a second subtransmission.

35. The double clutch transmission according to claim 34, wherein a fourth gear plane (10-14) and a fifth gear plane (11-15), each being a dual gear plane, comprise two fixed gearwheels (4, 5) on the first transmission input shaft (w_k1) of a first subtransmission.

36. The double clutch transmission according to claim 34, wherein a fourth gear plane (10-14) being a dual gear plane, and a fifth gear plane (11-5) and a sixth gear plane (6-15), each being a single gear plane, and the fourth gear plane, the fifth gear plane and the sixth gear plane respectively comprise three gearwheels (4, 5, 6) on the first transmission input shaft (w_k1) of a first subtransmission.

37. The double clutch transmission according to claim 26, wherein a first gear plane (8-12) and a second gear plane (9-13) are each a dual gear plane, comprise two gearwheels (1, 2) on the second transmission input shaft (w_k2) of a second subtransmission, and a third gear plane (10-14) and a fourth gear plane (11-15) are each a dual gear plane comprise two gearwheels (3, 4) on the first transmission input shaft (w_k1) of a first subtransmission.

38. The double clutch transmission according to claim 26, wherein a first gear plane (8-1) is a single gear plane and a second gear plane (9-13) is a dual gear plane which comprises two gearwheels (1, 2) on the second transmission input shaft (w_k2) of a second subtransmission.

39. The double clutch transmission according to claim 38, wherein a third gear plane (10-3) and a fourth gear plane (4-14) are each a single gear plane, and a fifth gear plane (11-15) is dual gear plane, and the third gear plane, the fourth gear plane and the fifth gear plane respectively comprise three gearwheels (3, 4, 5) on the first transmission input shaft (w_k1) of a first subtransmission.

40. The double clutch transmission according to claim 38, wherein a third gear plane (10-3), a fourth gear plane (4-14), a fifth gear plane (11-5) and a sixth gear plane (6-15), are each a single gear plane, and the third gear plane, the fourth gear plane, the fifth gear plane and the sixth gear plane respectively comprise four gearwheels (3, 4, 5, 6) of the first transmission input shaft (w_k1) of a first subtransmission.

41. The double clutch transmission according to claim 26, wherein
a first forward gear (G1) is shiftable as a winding path gear via the first clutch (K1), an activated sixth coupling device (F) and activation of the shift element (I) of the first countershaft (w_v1);
a second forward gear (G2) is shiftable via the second clutch (K2) and the activated sixth coupling device (F);
a third forward gear (G3) is shiftable via the first clutch (K1) and an activated third coupling device (C);
a fourth forward gear (G4) is shiftable via the second clutch (K2) and an activated second coupling device (B);
a fifth forward gear (G5) is shiftable via the first clutch (K1) and an activated fourth coupling device (D);
a sixth forward gear (G6) is shiftable via the second clutch (K2) and an activated fifth coupling device (E);
a seventh forward gear (G7) is shiftable via the first clutch (K1) and the activated eighth coupling device (H);
an eighth forward gear (G8) is shiftable as a winding path gear via the first clutch (K1), an activated first coupling device (A) and the activated shift element (I) of the first countershaft (w_v1);
at least one of a first reverse gear (R1) is shiftable via the first clutch (K1) and an activated seventh coupling device (G);
a second reverse gear (R2) is shiftable as a winding path gear via the second clutch (K2), the activated second coupling device (B), the activated fourth coupling device (D), the activated seventh coupling device (G), and upon disengagement of a first output coupling device (S_ab1); and
a third reverse gear (R3) is shiftable as a winding path gear via the first clutch (K1), the activated second coupling device (B), the activated fifth coupling device (E), the activated seventh coupling device (G), and upon disengagement of a second coupling device (S_ab2).

42. The double clutch transmission according to claim 41, wherein
at least one of a first crawler gear (C1) is shiftable as a winding path gear via the second clutch (K2), the activated third coupling device (C), the activated sixth coupling device (F), the activated eighth coupling device (H), and upon disengagement of the second coupling device (S_ab2);
a second crawler gear (C2) is shiftable as a winding path gear via the second clutch (K2), the activated fourth coupling device (D), the activated sixth coupling device (F), the activated eighth coupling device (H), and upon disengagement of the second coupling device (S_ab2);
a first overdrive gear (O1) is shiftable as a winding path gear via the second clutch (K2), the activated eighth coupling device (H) and the activated first shift element (I) of the first countershaft (w_v1); and
a second overdrive gear (O2) is shiftable as a winding path gear via the first clutch (K1), the activated second coupling device (B), the activated sixth coupling device (F), the activated eighth coupling device (H), and the upon disengagement of second coupling device (S_ab2).

43. The double clutch transmission according to claim 26, wherein
a first forward gear (G1) is shiftable as a winding path gear via the first clutch (K1), an activated fifth coupling device (E) and an activated second shift element (K) of the second countershaft (w_v2);
a second forward gear (G2) is shiftable via the second clutch (K2) and an activated fifth coupling device (E);
a third forward gear (G3) is shiftable via the first clutch (K1) and an activated seventh coupling device (G);
a fourth forward gear (G4) is shiftable via the second clutch (K2) and an activated sixth coupling device (F);
a fifth forward gear (G5) is shiftable via the first clutch (K1) and an activated fourth coupling device (D);
a sixth forward gear (G6) is shiftable via the second clutch (K2) and an activated first coupling device (A);
a seventh forward gear (G7) is shiftable via the first clutch (K1) and an activated third coupling device (C);
an eighth forward gear (G8) is shiftable as a winding path gear via the first clutch (K1), an activated second coupling device (B) and an activated first shift element (K);
one of a first reverse gear (R1) is shiftable via the first clutch (K1) via an activated eighth coupling device (H); and
a second reverse gear (R2) is shiftable as a winding path gear via the second clutch (K2), the activated first coupling device (A), the activated third coupling device (C), the activated eighth coupling device (H), and upon disengagement of a first output coupling device (S_ab1).

44. The double clutch transmission according to claim 43, wherein an overdrive gear (O1) is shiftable as a winding path gear via the second clutch (K2), the activated third coupling device (C) and the activated second shift element (K) of the second countershaft (w_v2).

45. The double clutch transmission according to claim 26, wherein
a first forward gear (G1) is shiftable as a winding path gear via the first clutch (K1), an activated sixth coupling device (F) and an activated first shift element (I) of the first countershaft (w_v1);
a second forward gear (G2) is shiftable via the second clutch (K2) and the activated sixth coupling device (F);
a third forward gear (G3) is shiftable via the first clutch (K1) and an activated third coupling device (C);
a fourth forward gear (G4) is shiftable via the second clutch (K2) and an activated second coupling device (B);
a fifth forward gear (G5) is shiftable via the first clutch (K1) and an activated seventh coupling device (G);
a sixth forward gear (G6) is shiftable via the second clutch (K2) and an activated first coupling device (A);
a seventh forward gear (G7) is shiftable via the first clutch (K1) and an activated fourth coupling device (D);
an eighth forward gear (G8) is shiftable as a winding path gear via the first clutch (K1), the activated second coupling device (B) and an activated second shift element (K) of the second countershaft (w_v2);
a first reverse gear (R1) is shiftable as a winding path gear via the second clutch (K2), the activated third coupling device (C), an activated fifth coupling device (E), the activated seventh coupling device (G), and upon disengagement of a second coupling device (S_ab2);
a second reverse gear (R2) is shiftable as a winding path gear via the first clutch (K1), the activated first coupling device (A), the activated third coupling device (C), the activated fifth coupling device (E), and upon disengagement of a first output coupling device (S_ab1);
a third reverse gear (R3) is shiftable as a winding path gear via the second clutch (K2), an activated eighth coupling device (H), and the activation of second coupling device (K) of the second countershaft (w_v2);
a fourth reverse gear (R4) is shiftable as a winding path gear via the second clutch (K2), the activated second coupling device (B), the activated fourth coupling device (D), the activated eighth coupling device (H), and upon disengagement of the first output coupling device (S_ab1); and
a fifth reverse gear (R5) is shiftable as a winding path gear via the second clutch (K2), the activated third coupling device (C), the activated sixth coupling device (F), the activated eighth coupling device (H), and upon disengagement of the second coupling device (S_ab2).

46. The double clutch transmission according to claim 45, wherein
a first crawler gear (C1) is shiftable as a winding path gear via the second clutch (K2), the activated third coupling device (C) and the activated second shift element (K) of the second countershaft (w_v2);
a second crawler gear (C2) is shiftable as a winding path gear via the first clutch (K1), the activated first coupling device (A), the activated third coupling device (C), the activated sixth coupling device (F), and upon disengagement of the first output coupling device (S_ab1);
a first overdrive gear (O1) is shiftable as a winding path gear via the second clutch (K2), the activated fourth coupling device (D) and the activated first shift element (I) of the first countershaft (w_v1);
a second overdrive gear (O2) is shiftable as a winding path gear via the second clutch (K2), the activated first coupling device (A), the activated third coupling device (C), the activated seventh coupling device (G), and upon disengagement of the first output coupling device (S_ab1); and
a third overdrive gear (O3) is shiftable as a winding path gear via the first clutch (K1), the activated first coupling device (A) and the activated second shift element (K) of the second countershaft (w_v2).

47. The double clutch transmission according to claim 26, wherein
a first forward gear (G1) is shiftable as a winding path gear via the first clutch (K1), an activated fifth coupling device (E) and an activated first shift element (I) of the second countershaft (w_v2);
a second forward gear (G2) is shiftable via the second clutch (K2) and an activated fifth coupling device (E);
a third forward gear (G3) is shiftable via the first clutch (K1) and an activated third coupling device (C);
a fourth forward gear (G4) is shiftable via the second clutch (K2) and an activated second coupling device (B);
a fifth forward gear (G5) is shiftable via the first clutch (K1) and an activated eighth coupling device (H);
a sixth forward gear (G6) is shiftable via the second clutch (K2) and an activated sixth coupling device (F);
a seventh forward gear (G7) is shiftable via the first clutch (K1) and an activated fourth coupling device (D);
an eighth forward gear (G8) is shiftable via the second clutch (K2), the activated third coupling device (C) and an activated second shift element (K) of the second countershaft (w_v2);
a first reverse gear (R1) is shiftable as a winding path gear via the second clutch (K2), an activated first coupling device (A), the activated fourth coupling device (D), an activated seventh coupling device (G), and upon disengagement of a first output coupling device (S_ab1);
a second reverse gear (R2) is shiftable as a winding path gear via the first clutch (K1), the activated first coupling device (A) and an activated first shift element (K) of the second countershaft (w_v2); and
a third reverse gear (R3) is shiftable as a winding path gear via the first clutch (K1), the activated first coupling device (A), the activated third coupling device (C), the activated fifth coupling device (E), and upon disengagement of the first output coupling device (S_ab1).

48. The double clutch transmission according to claim 47, wherein
a crawler gear (C1) is shiftable as a winding path gear via the second clutch (K2), the activated third coupling device (C), the activated fifth coupling device (E), the activated eighth coupling device (H), and upon disengagement of a second output coupling device (S_ab2);
a first overdrive gear (O1) is shiftable as a winding path gear via the second clutch (K2), the activated fourth coupling device (D) and the activated first shift element (I) of the first countershaft (w_v1);
a second overdrive gear (O2) is shiftable as a winding path gear via the second clutch (K2), the activated fourth coupling device (D), the activated sixth coupling device (F), the activated eighth coupling device (H), and upon disengagement of the second output coupling device (S_ab2); and
a third overdrive gear (O3) is shiftable as a winding path gear via the first clutch (K1), the activated second coupling device (B), the activated fourth coupling device (D), the activated sixth coupling device (F), and upon disengagement of the first output coupling device (S_ab1).

49. The double clutch transmission according to claim 26, wherein
a first forward gear (G1) is shiftable as a winding path gear via the first clutch (K1), an activated second coupling device (B) and an activated second shift element (K);
a second forward gear (G2) is shiftable via the second clutch (K2), the activated second coupling device (B);
a third forward gear (G3) is shiftable via the first clutch (K1) and an activated seventh coupling device (G);
a fourth forward gear (G4) is shiftable via the second clutch (K2) and an activated sixth coupling device (F);
a fifth forward gear (G5) is shiftable via the first clutch (K1) and an activated third coupling device (C);
a sixth forward gear (G6) is shiftable via the second clutch (K2) and an activated first coupling device (A);
a seventh forward gear (G7) is shiftable via the first clutch (K1) and an activated fourth coupling device (D);
an eighth forward gear (G8) is shiftable as a winding path gear via the first clutch (K1), the activated sixth coupling device (F) and an activated first shift element (I);
a first reverse gear (R1) is shiftable as a winding path gear via the first clutch (K1), the activated first coupling device (A), the activated fifth coupling device (E), the activated seventh coupling device (G), and upon disengagement of a first output coupling device (S_ab2);
a second reverse gear (R2) is shiftable as a winding path gear via the first clutch (K1), the activated second coupling device (B), the activated fifth coupling device (E), the activated seventh coupling device (G), and upon disengagement of the second output coupling device (S_ab2);
a third reverse gear (R3) is shiftable as a winding path gear via the second clutch (K2), the activated third coupling device (C), the activated sixth coupling device (F), the activated eighth coupling device (H), and upon disengagement of the second output coupling device (S_ab2);
a fourth reverse gear (R4) is shiftable as a winding path gear via the second clutch (K2), the activated fourth coupling device (D), the activated sixth coupling device (F), the activated eighth coupling device (H), and upon disengagement of the second output coupling device (S_ab2); and
a fifth reverse gear (R5) is shiftable via the first clutch (K1) and the activated eighth coupling device (H).

50. The double clutch transmission according to claim 49, wherein
a first crawler gear (C1) is shiftable as a winding path gear via the second clutch (K2), the activated seventh coupling device (G) and the activated first shift element (I) of the second countershaft (w_v2);
a second crawler gear (C2) is shiftable as a winding path gear via the second clutch (K2), the activated second coupling device (B), the activated fourth coupling device (D), the activated seventh coupling device (G), and upon disengagement of the first output coupling device (S_ab1);
a first overdrive gear (O1) is shiftable as a winding path gear via the second clutch (K2), the activated fourth coupling device (D) and the activated second shift element (K) of the second countershaft (w_v2);
a second overdrive gear (O2) is shiftable as a winding path gear via the first clutch (K1), the activated first coupling device (A), and the activated first shift element (I); and
a third overdrive gear (O3) is shiftable as a winding path gear via the first clutch (K1), the activated second coupling device (B), the activated fourth coupling device (D), the activated sixth coupling device (F), and upon disengagement of the first output coupling device (S_ab1).
